(19) United States
(12) Patent Application Publication
(10) Pub. No.: US 2024/0383574 A1
(43) Pub. Date: Nov. 21, 2024

(54) VESSEL

(71) Applicant: FORTESCUE LTD, Perth (AU)

(72) Inventors: David Hugh Michael Coleman, Perth (AU); Praveen Singh Tomar, Perth (AU)

(21) Appl. No.: 18/685,895

(22) PCT Filed: Aug. 25, 2022
(86) PCT No.: PCT/AU22/51022

§ 371 Date: Feb. 22, 2024

(30) Foreign Application Priority Data
Aug. 25, 2021 (AU) 2021221776
Aug. 25, 2021 (SG) 10202109291T

(51) Int. Cl. B63B 17/00; B63B 39/03; B63B 79/10; B63H 21/14; B63J 2/12

(52) U.S. Cl. CPC B63B 17/0027; B63B 39/03; B63B 79/10; B63H 21/14; B63J 2/12; B63J 2002/125

(57) ABSTRACT

A vessel including a hull, an upper deck, an accommodation structure extending above the upper deck, a propulsion system powered by ammonia as a fuel, and a tank for storing ammonia for supplying the propulsion system, wherein the tank is located aft of the accommodation structure.

### FIELD OF THE INVENTION

The present invention relates to a vessel and more particularly, but not exclusively, to a vessel powered by ammonia.

### BACKGROUND TO THE INVENTION

It is known to transport bulk product internationally by bulk product transportation vessels.

The applicant has identified that existing bulk product transportation vessels are typically powered by diesel, marine gasoil, bunker oil and/or other non-renewable fuels. Air pollution from engine operation is a serious concern with bulk product transportation vessels, particularly as large vessels are often run on low quality fuel oils, such as bunker oil, which is highly polluting and has been shown to be a health risk.

The applicant has identified that it would be advantageous for such vessels to be powered by a renewable fuel. However, the applicant encountered difficulties in developing a suitable vessel to be powered by a renewable fuel, particularly in providing sufficient fuel to provide a suitable range, and in packaging the vessel size to accommodate necessary parts.

Examples of the present invention seek to provide an improved bulk product transportation vessel which obviates or at least alleviates one or more disadvantages of existing vessels.

### SUMMARY OF THE INVENTION

In accordance with the present invention, there is provided a vessel including a hull, an upper deck, an accommodation structure extending above the upper deck, a propulsion system powered by ammonia as a fuel, and a tank for storing ammonia for supplying the propulsion system, wherein the tank is located aft of the accommodation structure.

Preferably, the tank is located entirely aft of the accommodation structure.

Preferably, the tank has a capacity equal to or greater than 5000 m³. More preferably, the tank has a capacity equal to or greater than 10,000 m³. Even more preferably, the tank has a capacity of approximately 11,000 m³ or 12,500 m³.

In a preferred form, the vessel is a carrier for transporting bulk product(s). More preferably, the vessel is a carrier for transporting dry bulk product(s). Alternatively, the vessel is a carrier for transporting wet bulk product(s). In one form, the vessel is a carrier for transporting ore.

Preferably, the tank has an upper portion above the upper deck and a lower portion below the upper deck.

In one form, the vessel is a twin skeg vessel.

In an alternative form, the vessel is a single skeg vessel.

Preferably, the tank is recessed in an engine room of the vessel.

The tank may be transversely located such that a longest dimension of the tank is oriented transversely of the vessel.

In one form, the vessel includes one or more ammonia fuel cells for auxiliary power.

The vessel may have an exhaust gas boiler including a heat recovery from a main engine as well as from one or more auxiliary engine(s).

Preferably, the vessel includes a battery energy storage system for supplying electricity.

In a preferred form, the vessel includes a high voltage shore power system. More preferably, the high voltage shore power system is a 6.6 kV shore power system.

Preferably, the vessel includes an on-board emission monitoring system. More preferably, the on-board emission monitoring stem is for monitoring carbon dioxide, NOx, SOx and/or methane. Even more preferably, the on-board emission monitoring system has an alarm which is activated when emissions exceed a predetermined level.

The vessel may include one or more twin screw engines.

Preferably, the vessel includes a shaft generator. More preferably, the shaft generator has power take off/power take in (PTO/PTI) technology. Even more preferably, the shaft generator generates power from a main engine of the vessel.

In a preferred form, the accommodation structure is in the form of an accommodation block.

Preferably, the vessel includes nine cargo holds.

In accordance with another aspect of the present invention, there is provided a vessel including a hull, an upper deck, an accommodation structure extending above the upper deck, a propulsion system powered by ammonia as a fuel, and a tank for storing ammonia for supplying the propulsion system.

Preferably, the tank is located aft of the accommodation structure.

The tank may be located underneath, to the starboard, to the port, or forward of the accommodation structure.

Preferably, the tank is recessed in the deck.

Alternatively, the tank is mounted on the deck.

In accordance with another aspect of the present invention, there is provided a vessel for transporting bulk product(s), the vessel including a hull, an upper deck, an accommodation structure extending above the upper deck, a propulsion system powered by ammonia as a fuel, and a tank configured for storing ammonia for supplying the propulsion system, wherein the tank is located aft of the accommodation structure and includes an upper portion above the upper deck and a lower portion below the upper deck.

Preferably, the tank is located entirely aft of the accommodation structure.

In accordance with another aspect of the present invention, there is provided a vessel for transporting bulk product(s), the vessel including a propulsion system powered by ammonia as a fuel and a tank configured for storing the fuel, wherein the tank is located at an aft end of the vessel and extends through an upper deck of the ship and into a hull and serves as ballast to thereby reduce the amount of ballast water required by the vessel.

Preferably, the tank comprises a plurality of stiffening plates to increase a fatigue strength thereof.

In a preferred form, the tank is at least partially recessed within an engine room of the vessel.

### BRIEF DESCRIPTION OF THE DRAWINGS

Preferred embodiments of the invention will be described, by way of a non-limiting example only, with reference to the accompanying drawings in which:

FIG. 1 shows a perspective view of a vessel in accordance with an example of the present invention;

FIG. 2 shows a rear perspective view of the vessel of FIG. 1;

FIG. 3 shows a side view of the vessel of FIG. 1;

FIG. 4 shows top, side and bottom transparent views of the vessel of FIG. 1;

FIG. 5 shows a perspective view of a vessel in accordance with another example of the present invention;

FIG. 6 shows a rear perspective view of the vessel of FIG. 5;

FIG. 7 shows a side view of the vessel of FIG. 5; and

FIG. 8 shows top, side and bottom transparent views of the vessel of FIG. 5.

### DETAILED DESCRIPTION

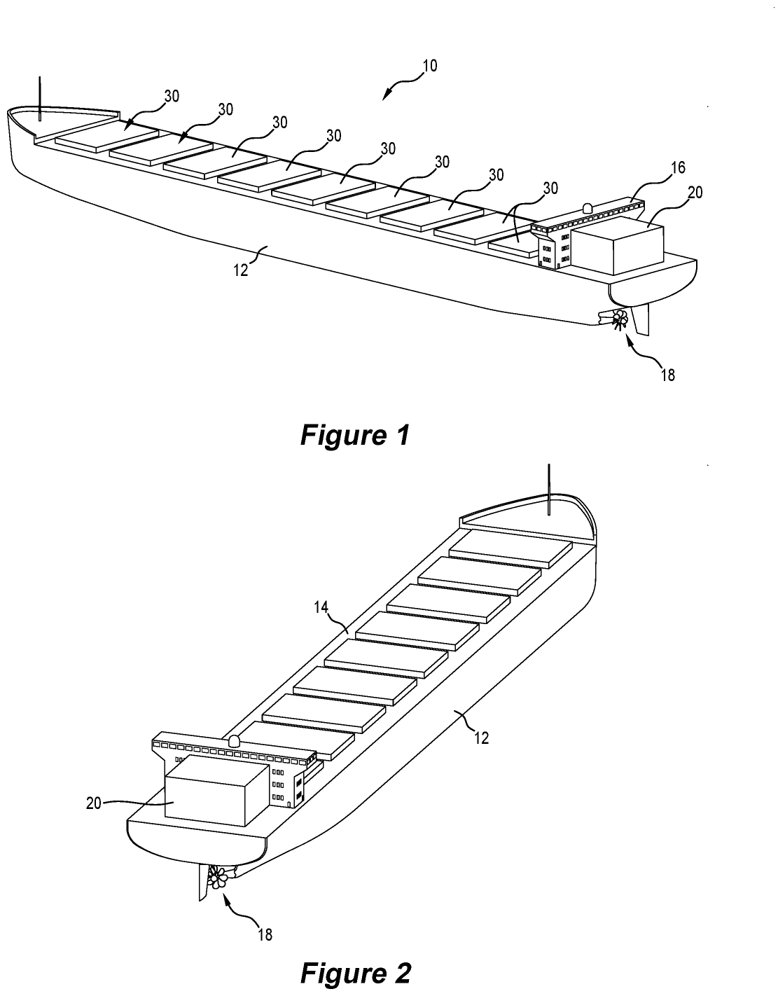

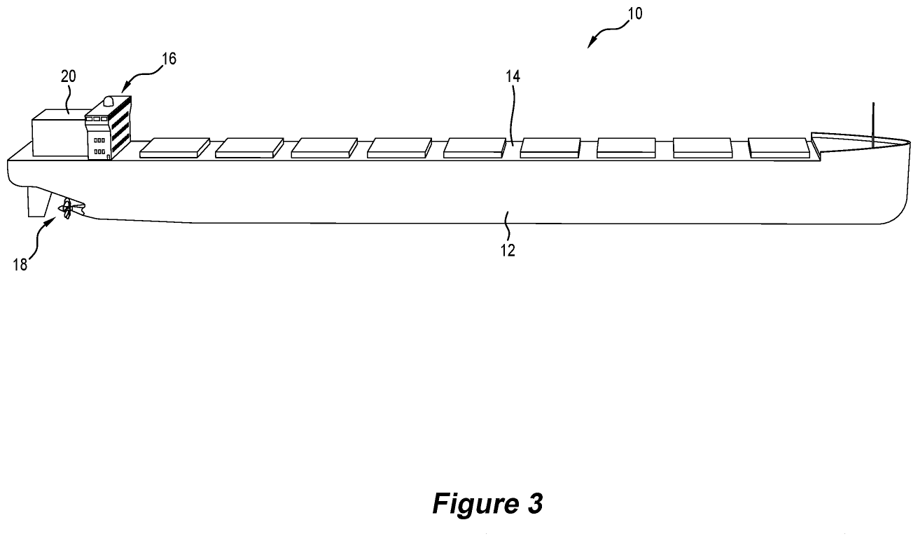

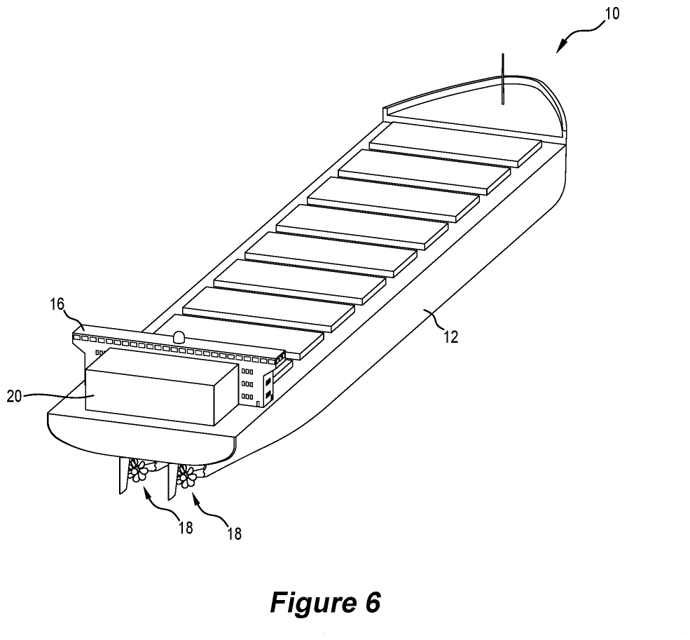

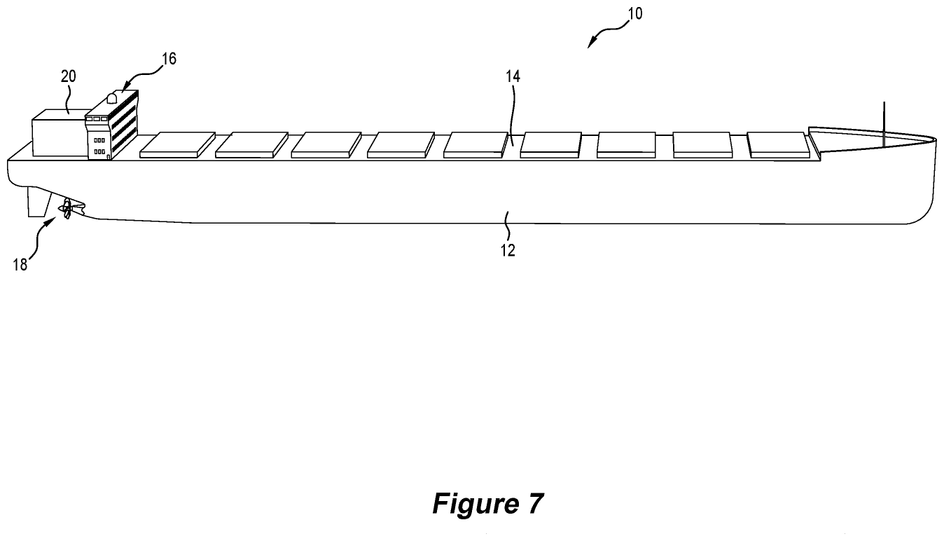

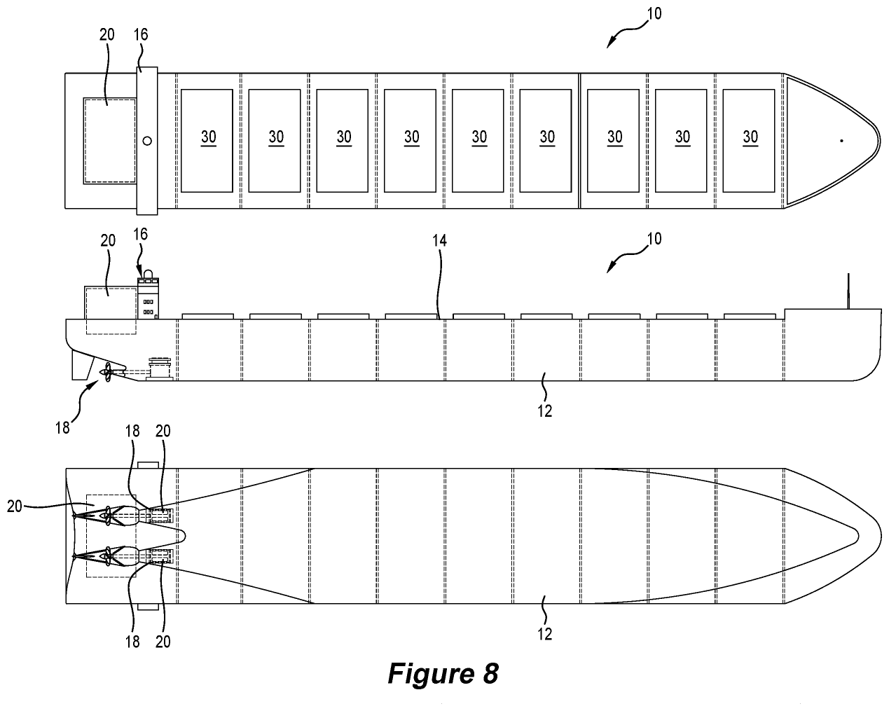

With reference to FIGS. 1 to 8 of the drawings, the applicant has determined that it would be advantageous to have a vessel for the transportation of bulk product, wherein the vessel is powered by ammonia fuel and includes a fuel tank to house sufficient ammonia to enable the vessel to have a useful range in travelling distance. The applicant has made an invention and has embodied the invention in example concepts relating to a Newcastlemax vessel in single skeg format, a Newcastlemax vessel in twin skeg format, a VLOC vessel in single skeg format (not shown in the drawings) and a VLOC vessel in twin skeg format (not shown in the drawings).

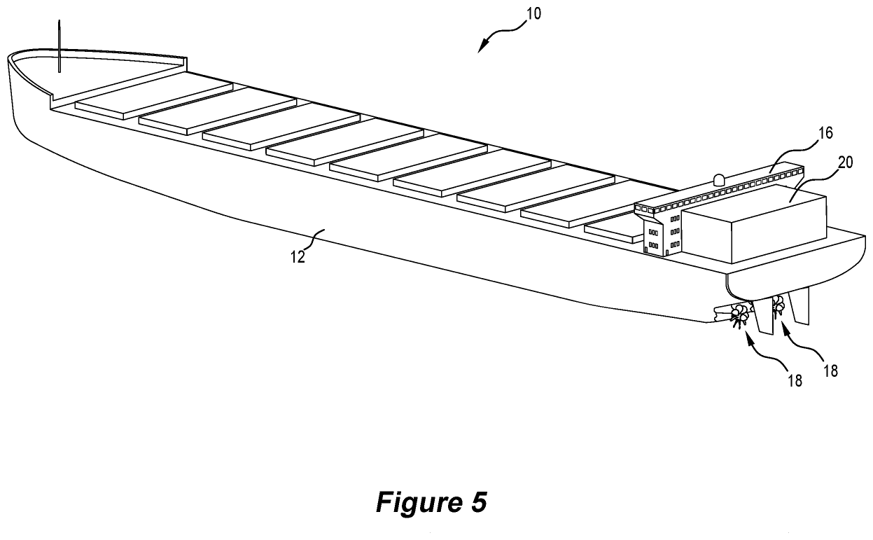

FIGS. 1 to 4 show the example of the Newcastlemax vessel in single skeg format and FIGS. 5 to 8 show the example of the Newcastle Max vessel in twin skeg format.

With reference to FIGS. 1 to 4, there is provided a vessel 10 including a hull 12, an upper deck 14, and an accommodation structure 16 extending above the upper deck 14. The vessel 10 also includes a propulsion system 18 powered by ammonia as a fuel, and a tank 20 for storing ammonia for supplying the propulsion system 18. The tank 20 is located aft of the accommodation structure 16. In one form, the ammonia tank 20 may extend such that approximately 60% of the height of the tank 20 is above the upper deck 14, whereas approximately 40% of the height of the tank 20 is below the upper deck 14. Also, in one particular example, a front bottom edge of the tank 20 may be chamfered. This chamfering of the tank 20 may facilitate packaging of an engine room of the vessel 10. A bottom part of the accommodation structure 16 below the upper deck 14 may be tapered outwardly at a corresponding angle so as to provide support to the ammonia tank 20. In this way, a rear most lower portion of the accommodation structure 16 may extend behind a front most wall of the ammonia tank 20.

In one example, the tank 20 may be located entirely aft of the accommodation structure 16. The tank 20 may have a capacity equal to or greater than 5,000 m³. More particularly, where a longer range is desirable, the tank 20 may have a capacity equal to or greater than 10,000 m³. In preferred examples of the invention, the tank 20 has a capacity of approximately 11,000 m³ or 12,500 m³. The tank 20 may provide the vessel 10 with a range of approximately 16,000 nautical miles, for example, covering two roundtrips between Australia and China. This may be particularly useful in facilitating journeys to other destinations and in refuelling in the most economical manner by utilising refuelling at relatively inexpensive locations. The specific model of the base vessel may vary and may be a Newcastlemax (shown in the drawings) or VLOC (very large ore carrier), by way of non-limiting example.

In the example shown, the vessel 10 is a carrier for transporting bulk product(s). The vessel 10 may be a carrier for transporting dry bulk product(s). Alternatively, the vessel 10 may be a carrier for transporting wet bulk product(s). In one form, the vessel 10 may be a carrier for transporting ore.

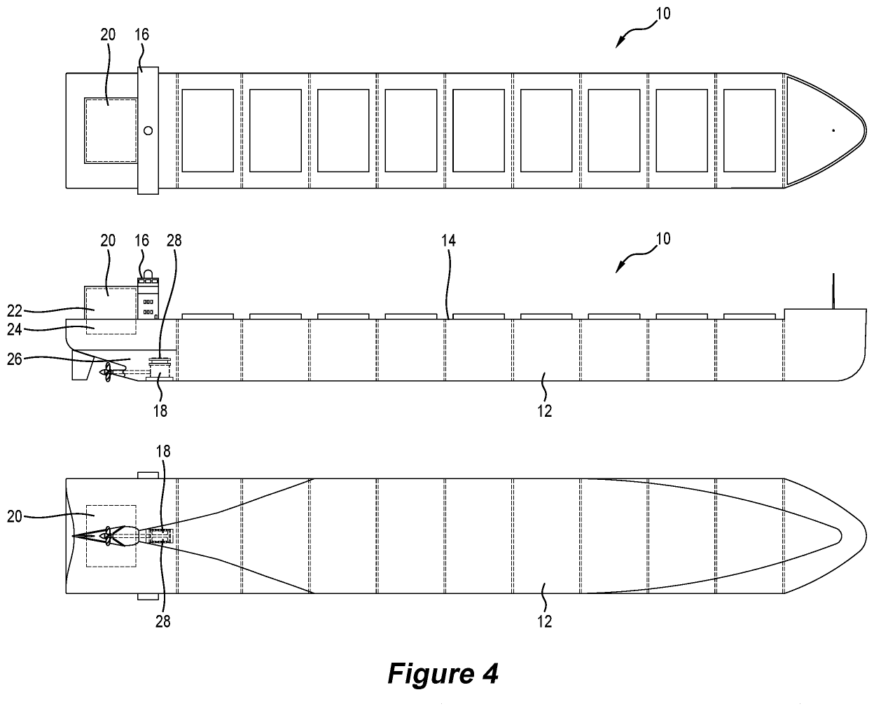

As can be seen most clearly in FIG. 4, the tank 20 has an upper portion 22 above the upper deck 14 and a lower portion 24 below the upper deck 14. In the example shown in FIGS. 1 to 4, the vessel 10 is a single skeg vessel.

In an alternative form (see FIGS. 5 to 8), the vessel 10 is a twin skeg vessel.

With reference to the side view in FIG. 4, the tank 20 may be recessed in an engine room 26 of the vessel 10.

As can be seen most clearly in the top view of FIG. 4, the tank 20 may be transversely located such that the longest dimension of the tank 20 is oriented transversely of the vessel 10.

The vessel 10 may include one or more ammonia fuel cells for auxiliary power.

The vessel 10 may have an exhaust gas boiler including a heat recovery from a main engine as well as from one or more auxiliary engine(s).

The vessel 10 may include a battery energy storage system for supplying electricity.

In one form, the vessel 10 includes a high voltage shore power system. The high voltage shore power system may be in the form of a 6.6 kV shore power system.

The vessel may include an on-board emission monitoring system. The on-board emission monitoring system may be arranged for monitoring carbon dioxide, NOx, SOx and/or methane emissions. In particular, the on-board emission monitoring system may have an alarm which is activated when emissions exceed a predetermined level.

The vessel 10 may include one or more twin screw engines.

In one form, the vessel 10 includes a shaft generator. The shaft generator may have power take off/power take in (PTO/PTI) technology. The shaft generator may be arranged to generate power from a main engine 28 of the vessel 10.

In single skeg form (see FIGS. 1 to 4), the main engine 28 may be in the form of a two-stroke main engine, using ammonia as a primary fuel. In one particular example, the main engine 28 may have power output rated at approximately 17,000 kW at 72 rpm. The engine 28 may be a dual fuel engine which is able to run on ammonia as well as on marine gasoil (MGO). Daily fuel consumption of ammonia may be approximately 132 tons, whereas daily fuel consumption of marine gasoil may be approximately 60 tons.

In twin skeg form (see FIGS. 5 to 8), the propulsion may include two main engines 28 each of which uses ammonia as a primary fuel source. Each of the engines 28 may have a power output rated at approximately 8350 kW to 9800 kW. Daily consumption of ammonia may be approximately 130 to 150 tons, whereas daily fuel consumption of marine gasoil may be approximately 57 to 67 tons. The presence of twin skegs may provide improved manoeuvrability, propulsion efficiency and redundancy. The improved manoeuvrability may be of particular advantage when docking at specific ports.

In an example form, the accommodation structure 16 may be in the form of a deckhouse. More particularly, the accommodation structure 16 may be in the form of an accommodation block.

The vessel 10 may include a cargo area consisting of multiple cargo holds 30. For example, in Newcastlemax form, the vessel 10 may include nine (9) cargo holds 30, whereas in VLOC form the vessel 10 may include seven (7) cargo holds. The vessel 10 may be suitable for carrying dry bulk cargoes such as grain, iron ore, coal, bauxite and/or other products. In one form, the total cargo hold volume may be approximately 230,000 m³. Advantageously, the high cargo volume and multiple cargo holds provide flexibility in loading.

The vessel 10 may have a plurality of auxiliary engines for generating electricity supply. The engines for generating electricity may use ammonia as a primary fuel and may also be able to operate continuously on low sulphur marine gasoil as a secondary fuel. Each of the electric generating engines may have an output of approximately 1400 kW at a speed of approximately 720 rpm.

### Ammonia Tank Structure

The ammonia tank 20 may be constructed of steel. A material grade of the steel is chosen to be compatible with ammonia storage temperature of −33° C. The tank 20 may be constructed of longitudinally stiffened plates supported by transverse web frames. Particular design may be incorporated to ensure suitable fatigue strength.

The ammonia tank 20 may be surrounded by a secondary barrier. An enclosure in the form of a cofferdam may be provided between the secondary barrier and all other spaces except a tank connection space. The secondary barrier and the cofferdam may incorporate a longitudinally stiffened steel plate structure supported by transverse webs.

### Innovative Advances

The applicant has made a number of innovative advances in the design of the vessel, including, but not limited to, the following:
1. Shallow draft and broader beam.
2. Twin skeg to assist manoeuvrability safety at particular ports such as, for example, Port Hedland.
3. Ammonia A-type of tank recessed in engine room and transversely located at aft of the accommodation block.
4. No bridging with LNG.
5. A-type tank selected with fatigue strength to be carried out for B-Type tank during detail design stage.
6. 7 Hold-7 hatch VLOC to reduce SAG.
7. Increased size of hatch cover opening to have a better spread of the cargo while loading.
8. EEDI 86% below EEDI Phase 3 baseline.
9. Accommodation structure 16 in the form of an aerodynamic accommodation block.
10. Space reservation for ammonia fuel cells.
11. Exhaust gas boiler with additional section for heat recovery from two auxiliary engine(s) on 85% load.
12. Additional safety features to tackle possible toxicity of ammonia releasing to the atmosphere.
13. Installation of variable frequency drives.
14. Battery energy storage system of about 850 kWh with long cycle life capability.
15. High voltage shore power system.
16. Onboard emission monitoring system.
17. Reduced consumption of fuel by twin screw engines due to smaller size engine, thus optimizing the propulsion with relatively low energy consumption.
18. Shaft generator has power take off/power take in (PTO/PTI) technology.

As will be appreciated from the above, the applicant addressed a number of difficulties in designing a suitable vessel. For example, there were difficulties in adapting the vessel to accommodate a relatively large ammonia tank. The applicant identified that a large ammonia fuel tank, if located forward of an accommodation space at mid-ship would have resulted in loss of cargo carrying capacity of the vessel.

Other difficulties encountered during the design included the following:
1. Endurance of the vessel to complete two round voyages.
2. Sloshing of the fuel inside the tank.
3. Visibility restriction due to height of the tank to achieve the endurance of the vessels.
4. Relocation of mooring winches and equipment inside the engine room.
5 Main engine maintenance height restrictions.
6. Weight of the tank 20 and structural strength of the tank 20.
7. Access route to lifeboats in case of emergency, additional safety measures to be in place.

Advantageously, the applicant identified that it would be beneficial to design the vessel 10 directly as an ammonia propelled vessel, rather than following bridging technology from existing LNG arrangements.

As there are not yet established rules for ammonia to be used as a fuel published by any flag state and/or classification society, the inventors had to use their inventive faculties to design a suitable layout of a vessel to safely use ammonia as a fuel.

In equal sailing conditions, in rough terms, a vessel 10 in accordance with an example of the present invention may use about 20,000 m³ less of ballast water relative to the amount required in existing vessels.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### LIST OF NUMBERED FEATURES

Vessel 10
Hull 12
Upper deck 14
Accommodation structure 16
Propulsion system 18
Tank 20
Upper portion 22
Lower portion 24
Engine room 26
Main engine 28
Cargo holds 30

1. A vessel including a hull, an upper deck, an accommodation structure extending above the upper deck, a propulsion system powered by ammonia as a fuel, and a tank for containing ammonia for supplying the propulsion system, wherein the tank is located aft of the accommodation structure and wherein the tank includes an upper portion above the upper deck and a lower portion below the upper deck.

2. A vessel as claimed in claim 1, wherein the tank is located entirely aft of the accommodation structure.

3. A vessel as claimed in claim 1, wherein the tank has a capacity equal to or greater than 5000 m³.

4. (canceled)

5. (canceled)

6. (canceled)

7. A vessel as claimed in claim 1, wherein the vessel is a carrier for transporting bulk product(s).

8. (canceled)

9. (canceled)

10. (canceled)

11. A vessel as claimed in claim 1, wherein the vessel is a twin skeg vessel.

12. (canceled)

13. (canceled)

14. A vessel as claimed in claim 1, wherein the tank is transversely located such that the longest dimension of the tank is oriented transversely of the vessel.

15. A vessel as claimed in claim 1, wherein the vessel includes one or more ammonia fuel cells for auxiliary power.

16. A vessel as claimed in claim 1, having an exhaust gas boiler including a heat recovery from a main engine as well as from one or more auxiliary engine(s).

17. A vessel as claimed in claim 1, wherein the vessel includes a battery energy storage system for supplying electricity.

18. A vessel as claimed in claim 1, wherein the vessel includes a high voltage shore power system.

19. (canceled)

20. A vessel as claimed in claim 1, wherein the vessel includes an on-board emission monitoring system.

21. (canceled)

22. (canceled)

23. A vessel as claimed in claim 1, including one or more twin screw engines.

24. A vessel as claimed in claim 1, including a shaft generator.

25. A vessel as claimed in claim 24, wherein the shaft generator has power take off/power take in (PTO/PTI) technology.

26. A vessel as claimed in claim 25, wherein the shaft generator generates power from a main engine of the vessel.

27. A vessel as claimed in claim 1, wherein the accommodation structure is in the form of an accommodation block.

28. (canceled)

29. (canceled)

30. (canceled)

31. (canceled)

32. (canceled)

33. (canceled)

34. (canceled)

35. (canceled)

36. A vessel including a hull, an upper deck, a propulsion system powered by ammonia as a fuel and a tank containing ammonia for supplying the propulsion system, wherein the tank is located at an aft end of the vessel and extends through the upper deck and into the hull, the tank serving as ballast to thereby reduce the amount of ballast water required by the vessel.

37. A vessel as claimed in claim 36, wherein the tank comprises a plurality of stiffening plates to increase a fatigue strength thereof.

38. A vessel as claimed in claim 36, wherein the tank is at least partially recessed within an engine room of the vessel.

39. A vessel as claimed in claim 36, wherein the vessel includes an accommodation structure extending above the upper deck and wherein the tank is located aft of the accommodation structure.
